(19) United States
(12) Patent Application Publication
(10) Pub. No.: US 2002/0057237 A1
(43) Pub. Date: May 16, 2002

(54) LCD monitor

(75) Inventors: S. K. Lin, Taipei Hsien (TW); David Lin, Taipei (TW)

Correspondence Address: DARBY & DARBY P.C., 805 Third Avenue, New York, NY, 10022, US

(73) Assignee: Arch Technology Inc.

(21) Appl. No.: 09/764,750

(22) Filed: Jan. 18, 2001

(30) Foreign Application Priority Data
Nov. 13, 2000 (TW) 89124008

(51) Int. Cl. G09G 3/36

(52) U.S. Cl. 345/87

(57) ABSTRACT

A panel module having a gate driver and a source driver; a control board disposed on a first side of the panel module, comprising: an input interface for receiving plural types of video signals, adapted to select a first-type video signal from the plural types of video signals and generate a first digital video signal according to the first-type video signal; a scaler module, comprising a time control unit, and is provided to receive the first digital video signal; and a micro-processing device, adapted to output a first control signal that controls the scaler module to generate a gate/source-driving signal for the gate driver and the source driver according to the first digital video signal. The LCD monitor further comprises a frame structure, covering the periphery of the panel module; and a cover structure conjugated with the frame structure in the aspect of the first side, used to cover the first side of the panel module and the control board thereon.

### FIELD OF THE INVENTION

The present invention relates to a LCD monitor, and particularly relates to a LCD monitor that is easy to assemble.

### DESCRIPTION OF THE PRIOR ART

The structure of a conventional LCD monitor (not shown) could be substantially distributed into parts of: a case module, a panel module, a control PCB module and a main board module. The panel module comprises a source driver and a gate driver for driving the plurality of pixels on the panel module. The control PCB module mainly comprises a scaler, a micro-processing device, and an input interface, wherein the input interface (usually comprises an A/D converter) is provided for receiving plural types of video signals and converting the video signals into digital video signals; the micro-processing device is provided for controlling the scaler to receive the digital video signals and generate corresponding control signals for the main board.

The main board of a conventional monitor mainly comprises a signal processor. The main board is disposed on the backside (non-displaying side) of the panel module. The signal processor is provided to receive the control signals and generate corresponding source/gate-driving signals for the source driver and the gate driver of the panel module. There is a time control unit (TCON) included in the signal processor, and thereby the source/gate-driving signals are provided with the form of pulses in types of driving formats, so as to control the performances of the pixels in predetermined conditions, for example, offsetting the feed-through induced by the capacitor effects of the transistors (e.g., TFT) within the pixels, and preventing the twinkling effect of the LCD panel.

In fabrication, firstly, a frame structure is mounted on the periphery of the panel module, and then the control PCB module is coupled to the main board module with a bus line, such as a TCP device. Next, a PCB shell is mounted upon the control PCB module, wherein the PCB shell is used for resisting the electromagnetic interferences from the environment. At last, mounting a back cover for constructing a case for the entire LCD monitor in associated with the frame structure. Nowadays, for economic purposes, there is a tendency towards “labor division” in industrial circles. For manufacturers, after producing the above-mentioned modules, the LCD monitors are generally transported in parts to predetermined regions, such as market places or low-priced-manpower regions, based on economies. The parts of the LCD monitors are then fabricated in local factories. In the above-mentioned processes, however, additional expenses are required for labor-training and fabricating devices. On the other hand, there is no guarantee that the qualities of local labor in fabricating places will be satisfactory. Therefore, a simpler modular arrangement for LCD monitors associated with a simpler procedure for fabricating (or assembly) is desired.

### SUMMARY OF THE INVENTION

Accordingly, to satisfy the above-mentioned requirement, the present invention provides a LCD monitor, comprising: a panel module having a gate driver and a source driver; a control board disposed on a first side of the panel module, comprising: an input interface for receiving plural types of video signals, adapted to select a first-type video signal from the plural types of video signals and generate a first digital video signal according to the first-type video signal; a scaler module, comprising a time control unit, and is provided to receive the first digital video signal; and a micro-processing device, adapted to output a first control signal that controls the scaler module to generate a gate/source-driving signal for the gate driver and the source driver according to the first digital video signal. The LCD monitor further comprises a frame structure, covering the periphery of the panel module; and a cover structure conjugated with the frame structure in the aspect of the first side, used to cover the first side of the panel module and the control board thereon.

The plural types of video signals further comprise an EDID signal, and the control board further comprises a memory device for storing the EDID signal, wherein the first-type video signal is provided from a computer, and the first digital signal comprises RGB signals, wherein the input interface comprises an A/D converter, wherein the input interface is further adapted to select a second-type video signal from the plural types of video signals, and generate a second digital video signal according to the second-type video signal to the scaler module, whereby the micro-processing device outputs a second control signal that controls the scaler module to generate the gate/source-driving signal according to the second digital video signal, wherein the second-type video signal is from a video device.

The LCD monitor further comprises a switching board that is adapted to provide a switching signal to the scaler module, whereby adjusting the gate/source-driving signal.

The LCD monitor further comprises a power module for supplying electric power to the LCD monitor, wherein the power module comprises an AC/DC adapter for converting an alternating current source into at least one direct current source, wherein the direct current source is adapted to supply the LCD with monitor direct current, wherein the AC/DC adapter is disposed on the control board. Moreover, the cover structure is fabricated from materials for resisting electromagnetic effects.

### BRIEF DESCRIPTION OF THE DRAWINGS

The present invention can be fully understood from the following detailed description and preferred embodiment with reference to the accompanying drawings in which:

FIG. 1 shows the construction of a LCD monitor according to an embodiment of the present invention.

FIG. 2 is a block diagram illustrating the structure of a LCD monitor according to an embodiment of the present invention.

### DETAILED DESCRIPTION OF THE EMBODIMENT

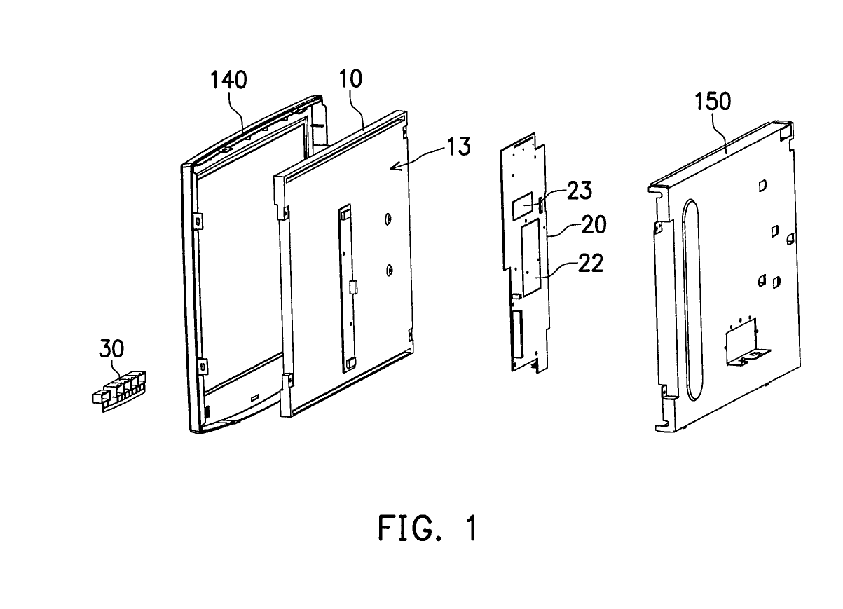

As shown in FIG. 1, the present embodiment is a LCD monitor 200, comprising: a panel module 10 having a gate driver 11 and a source driver 12; a control board 20 disposed on a first side 13 (non-display side)of the panel module 10, comprising an input interface 21 for receiving plural types of video signals VS, adapted to select a first-type video signal VS1 from the plural types of video signals and generating a first digital video signal DVS1 according to the first-type video signal VS1.

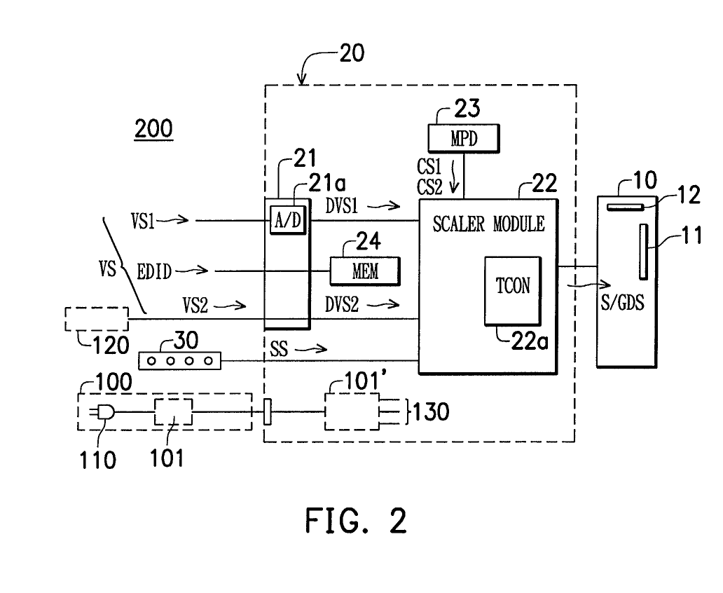

As shown in FIG. 2, The control board 20 further comprises a scaler module 22. The scaler module 22 has an above-mentioned signal processor, that is, scaler module 22 includes a time control unit (TCON) 22a that provides the source/gate-driving signals with a form of pulses in types of driving formats, so as to control the performances of the pixels in predetermined conditions. As an example of the controlling operation, the scaler module 22 can provide a source/gate-driving signals S/GDS of the accompanying series of pulses of varying amplitudes, so as to offset the feed-through induced by the capacitor effects of the transistors (e.g. TFT) within the pixels and to prevent the twinkling effect of the LCD panel. Moreover, as shown in FIG. 2, the control board 20 comprises a micro-processing device 23 which could be included with a programmable device, such as an 8051-series chip. The micro-processing device 23 is adapted to output a first control signal CS1 to the scaler module 22, and the scaler module 22 then generate the gate/source-driving signal for the gate driver 11 and the source driver 12 according to the first control signal CS1.

In the case of the LCD monitor 200, as shown in FIG. 1, there is a frame structure 140, covering the periphery of the panel module 10, so as to forma “front frame” of the monitor. Besides, there is further a cover structure 150 for conjugating the frame structure in the aspect of the backside of the panel module 10, and covering the control board 20 thereon simultaneously. Preferably, the cover structure is fabricated from materials for resisting electromagnetic effects, such as aluminum alloys.

To go a step further, as shown in FIG. 2, the plural types of video signals preferably comprise an EDID (Extended Display Identification Data) signal, which is provided as a communicating protocol between a host computer (not shown) and the LCD monitor, wherein the above-mentioned first-type video signal VS1 is provided from the host computer. Accordingly, it is preferable that the control board comprises a memory device for storing the EDID signal, and the first digital signal comprises typical RGB signals.

Moreover, the input interface 21 comprises an A/D converter 21a for the converting operation mentioned above.

Preferably, the input interface 21 is further adapted to select a second-type video signal VS2 (e.g. from a video recorder, not shown) from the plural types of video signals, and generate a second digital video signal DVS2 according to the second-type video signal VS2 to the scaler module 22, and the micro-processing device 23 preferably outputs a second control signal CS2, whereby controlling the scaler module 22 to generate the gate/source-driving signal G/SDS according to the second digital video signal DVS2.

As shown in FIG. 2, the LCD monitor 200 preferably comprises a typical switching board 30 that adapted to provide a switching signal SS to the scaler module, whereby adjusting the gate/source-driving signal and adjusting the performance of the LCD monitor 200, such as the brightness of a picture displayed.

As shown in FIG. 2, the LCD monitor 200 further comprises a power module 100 for supplying electric power to the LCD monitor 200. The power module 100 comprises an AC/DC adapter 101 for converting an alternating current source 110 into a direct current source 120, and the direct current source 120 is adapted to supply direct currents to the LCD monitor 200.

Moreover, the AC/DC adapter 101 could be disposed on the control board (indicated by number 101′ in FIG. 2), and the fabrication of the LCD monitor 200 of the present invention could be further simplified.

In fabrication, because there is only one PCB (the control board 20) in one LCD monitor of the present invention, the processes are only mounting the frame structure 140 upon the periphery of the panel module 10, disposing the control PCB module on the backside of the panel module 10, and then covering the cover structure 150 upon the backside of the panel module 10 so as to cover the control board 20. The procedure is obviously simplified. According to the present invention, the cost for labor-training and fabricating devices could be reduced, and the yield of production could be further improved.

While the invention has been described with reference to a preferred embodiment, the description is not intended to be construed in a limiting sense. It is therefore contemplated that the appended claims will cover any such modifications or embodiments as may fall within the scope of the invention defined by the following claims and their equivalents.

What is claimed is:

1. A LCD monitor, comprising:
A panel module having a gate driver and a source driver;
A control board disposed on a first side of the panel module, comprising:
An input interface for receiving plural types of video signals, adapted to select a first-type video signal from the plural types of video signals and generate a first digital video signal according to the first-type video signal;
A scaler module, comprising a time control unit, and is provided to receive the first digital video signal; and
A micro-processing device, adapted to output a first control signal that controls the scaler module to generate a gate/source-driving signal for the gate driver and the source driver according to the first digital video signal;
A frame structure, covering the periphery of the panel module; and
A cover structure conjugating the frame structure in the aspect of the first side, and covering upon the first side of the panel module and the control board thereon.

2. The LCD monitor of claim 1, wherein the plural types of video signals further comprise an EDID signal, and the control board further comprises a memory device for storing the EDID signal.

3. The LCD monitor of claim 1, wherein the first-type video signal is provided from a computer, and the first digital signal comprises RGB signals.

4. The LCD monitor of claim 3, wherein the input interface comprises an A/D converter.

5. The LCD monitor of claim 4, wherein the input interface is further adapted to select a second-type video signal from the plural types of video signals, and generate a second digital video signal according to the second-type video signal to the scaler module, and the micro-processing device outputs a corresponding second control signal that controls the scaler module to generate the gate/source-driving signal according to the second digital video signal, wherein the second-type video signal is from a video device.

6. The LCD monitor of claim 5, further comprising a switching board that is adapted to provide a switching signal to the scaler module, whereby adjusting the gate/source-driving signal and regulating the performance of pictures displayed on the panel module.

7. The LCD monitor of claim 6, further comprising a power module for supplying electric power to the LCD monitor.

8. The LCD monitor of claim 7, wherein the power module comprises an AC/DC adapter for converting an alternating current source into at least one direct current source, wherein the direct current source is adapted to supply the LCD monitor direct currents.

9. The LCD monitor of claim 8, wherein the AC/DC adapter is disposed on the control board.

10. The LCD monitor of claim 9, wherein the cover structure is fabricated from materials for resisting electromagnetic effects.
